(19) United States
(12) Patent Application Publication
(10) Pub. No.: US 2007/0102943 A1
(43) Pub. Date: May 10, 2007

(54) Coilable article retriever

(76) Inventor: Mark W. Casey, Lisle, IL (US)

Correspondence Address: Christopher J. Scott, P.O. Box 694, W Dundee, IL, 60118, US

(21) Appl. No.: 11/271,464

(22) Filed: Nov. 10, 2005

(51) Int. Cl. B66C 1/42; E21B 31/00

(52) U.S. Cl. 294/86.29; 294/86.4

(57) ABSTRACT

An article-retrieving apparatus enables a user to retrieve articles located inferior relative to the user. The apparatus comprises a coilable sleeve assembly, a handle assembly, and an article-grabbing assembly. The sleeve assembly comprises a force-translating inner member and a force-guiding outer sleeve. The inner member is slidably received within the outer sleeve. The handle assembly is cooperatively associated with a first sleeve assembly end and enables the user to impart an operative force to the inner member. The inner member is thus displaceable relative to the outer sleeve. The article-grabbing assembly is cooperatively associated with a second sleeve assembly end and comprises a plurality of cooperatively operative article-grabbing members. The article-grabbing members may thus retain a fetchable article located inferior relative to the user and the sleeve assembly is manually recoilable for retrieving the fetched article.

### BACKGROUND OF THE INVENTION

1. Field of the Invention

The present invention generally relates to a device for enabling a user to retrieve articles that have been displaced from the immediate reach of the user. More particularly, the present invention relates to an article retrieving system for retrieving articles at spatially distant, inferior locations relative to the user so that the user need not descend to the distant article and re-ascend to the user's preferred superior spatial location.

2. Description of the Prior Art

Deer hunting is ancient. Modem day deer hunters come in all shapes and sizes and any number of hunting accessories aids the hunter in his or her quest to land that prize stud. In this last regard, it is noted that a common vantage point for many deer hunters is a tree stand from which perch the hunter can lie in wait, virtually unseen, for his prey. Tree stands, however, require the user to amble up a tree a sufficient distance so that the hunter is not otherwise detected by the hunted. Often times, when the hunter has finally secured his final vantage point, typically after expending considerable effort, some must-have accessory is lost to gravity. Rather than descending from the hunter's hard-won vantage point to retrieve the accessory or article, it would be beneficial to have on hand a so-called long distance article retriever as a means to retrieve the fallen article with minimized effort and distraction. In this regard, it is noted that the prior art teaches a number of article-retrieving systems. Several of the more pertinent prior art disclosures relating to (hunting type) article retrieving devices and or assemblies are briefly described hereinafter.

U.S. Pat. No. 1,271,435 ('435 Patent), which issued to Cloutier, discloses a Clothes Hook. The '435 Patent teaches a drop line hook device comprising a pair of similar V-shaped spring members arranged flatwise directly against each other with the shanks of each member in contact with those of the other member, the free ends of each pair of contacting shanks being formed with oppositely projecting hooks, a retaining member individual to each of said pairs of contacting shanks fitted over the same in relatively fixed position to constantly hold them in contacting relation, and a member slidable over both of said retaining members to control the movements of said pairs of contacting shanks toward and from each other.

U.S. Pat. No. 5,388,877 ('877 Patent), which issued to Wenk, discloses a Hunting Bow Retriever. The '877 Patent teaches a hunting bow retrieval device releasably engagable with a hunting bow to allow a treebound hunter to raise and lower the hunting bow to the hunting position. The hunting bow retriever comprises a reel mounted in an enclosed palm-sized casing and a line wound on the reel and extending out of the casing. The line has an open-hook on the end that permits remote release of the bow. The casing is attached to a hunter with a belt clip. A foldable handle assembly engages the reel to implement rotational movement. A thumb brake allows a controlled release of said tension member from the wound position.

U.S. Pat. No. 5,613,721 ('721 Patent), which issued to Mullins, discloses a Retrieving Aid. The '721 Patent teaches an apparatus for raising, lowering, or retrieving an article, such as an arrow or an article of clothing, to or from an elevated position relative to the ground, such as a tree stand, includes a foldable hook assembly connected with a cord. The foldable hook assembly includes a pair of spaced generally parallel body members defining a space therebetween adapted to receive an arrow, spacers arranged between the body members, and a pair of fork arms pivotally connected with the body members. The fork arms are provided with angled surfaces which facilitate engagement of the item and allow the apparatus to slide along the ground. The ends of the fork arms are provided with barbs which allow soft articles, such as articles of clothing, to be engaged.

U.S. Pat. No. 6,106,042 ('042 Patent), which issued to McCloy, Jr., discloses a Device for Retrieving Items. The '042 Patent teaches a manually-operable device for use by tree stand hunters for retrieving items that have been left on the ground or that have fallen from the hunter or tree stand onto the ground. The device comprises an elongated shank, a rope having one end attached to the shank and an opposite end for grasping by the hunter situated in the tree stand, a plurality of flexible arms attached to the shank which are movable from an open position to a gripping position and are radially disposed circumjacent the longitudinal axis of the shank, a trigger plate slidably mounted on the arms for selectively spreading the arms and selectively closing the arms so that the item can be retrieved and released, and a weighted disc mounted on the shank for linear, reciprocable movement thereon so that the movement of the disc on the shank causes the disc to contact the trigger plate thereby forcing the trigger plate to slide on the arms, thus drawing the arms toward the shank axis so that the arms engage and retrieve the item.

It will be seen from an inspection of the above-referenced patents and other relevant prior art known to exist that the prior art does not teach an article-retrieving apparatus for enabling a user thereof to retrieve articles located inferior relative to the user comprising a coilable sleeve assembly, a handle assembly, and an article-grabbing assembly. The prior art thus perceives a need for an article-retrieving apparatus for enabling a user thereof to retrieve articles located inferior relative to the user comprising a coilable sleeve assembly, a handle assembly, and an article-grabbing assembly.

### SUMMARY OF THE INVENTION

To achieve the foregoing and other readily apparent objectives, the present invention provides an article-retrieving apparatus for enabling a user to retrieve articles located inferior relative to the user. The apparatus comprises a coilable sleeve assembly, a handle assembly, and an article-grabbing assembly. The sleeve assembly comprises a force-translating inner member and a force-guiding outer sleeve. The inner member is slidably received within the outer sleeve. The handle assembly is cooperatively associated with a first sleeve assembly end and enables the user to impart an operative force to the inner member. The inner member is thus displaceable relative to the outer sleeve. The article-grabbing assembly is cooperatively associated with a second sleeve assembly end and comprises a plurality of cooperatively operative article-grabbing members. The article-grabbing members may thus retain a fetchable article located inferior relative to the user and the sleeve assembly is manually recoilable for retrieving the fetched article.

Other objects of the present invention, as well as particular features, elements, and advantages thereof, will be elucidated or become apparent from, the following description and the accompanying drawing figures.

### BRIEF DESCRIPTION OF THE DRAWINGS

Other features of my invention will become more evident from a consideration of the following brief description of my patent drawings, as follows:

FIG. 1 is a fragmentary side view depiction of a user perched in a superior vertical location outfitted with certain gear, including a hat, a hunting bow, and a packaged and coiled article-retrieving system as taught by the present invention.

FIG. 2 is a fragmentary side view depiction of the user shown in FIG. 1 showing the user utilizing the unpackaged and partially uncoiled article-retrieving system of the present invention to grab the hat shown in FIG. 1, which hat has become inferiorly displaced relative to the user.

FIG. 3 is a fragmentary enlarged side view of an uncoiled portion of the coil assembly as taken from FIG. 2 showing an inner member as received within an outer sleeve.

FIG. 4 is a transverse cross-sectional view of the uncoiled portion of the coil assembly as taken from FIG. 3, showing a preferred construction of the inner member.

FIG. 4(a) FIG. 4 is a transverse cross-sectional view of an uncoiled portion of an alternative coil assembly of the present invention, showing an alternative construction of the inner member.

FIG. 5 is a fragmentary enlarged side view of a coiled portion of the coil assembly of the present invention showing an inner member as displaceably received within an outer sleeve.

FIG. 6 is a fragmentary cross-sectional side view of a first hand-operable assembly as cooperatively associated with a first article-grabbing assembly of the present invention.

FIG. 7 is a fragmentary cross-sectional side view of a second hand-operable assembly as cooperatively associated with a second article-grabbing assembly of the present invention.

FIG. 8 is a fragmentary enlarged cross-sectional side view depiction of the first article-grabbing assembly grabbing the inferiorly located hat depicted in FIG. 2.

FIG. 9 is a fragmentary enlarged cross-sectional side view depiction of the second article-grabbing assembly grabbing the inferiorly located hat depicted in FIG. 2.

FIG. 10 is a diagrammatic depiction of an electro-mechanical coilable article-retrieving system of the present invention showing a simple circuit comprising a switch at a first hand-operable end and a black box at a second, article-grabbing end, the black box housing electro-mechanical structure for selectively operating an article-grabbing assembly as selectively operated by current as driven by an electric potential and a selectively closeable switch.

FIG. 11 is a fragmentary side view depiction of the user shown in FIG. 2 showing the user manually coiling the partially uncoiled article-retrieving system of the present invention to retrieve the grabbed hat shown in FIG. 2.

### DETAILED DESCRIPTION OF THE PREFERRED EMBODIMENT(S)

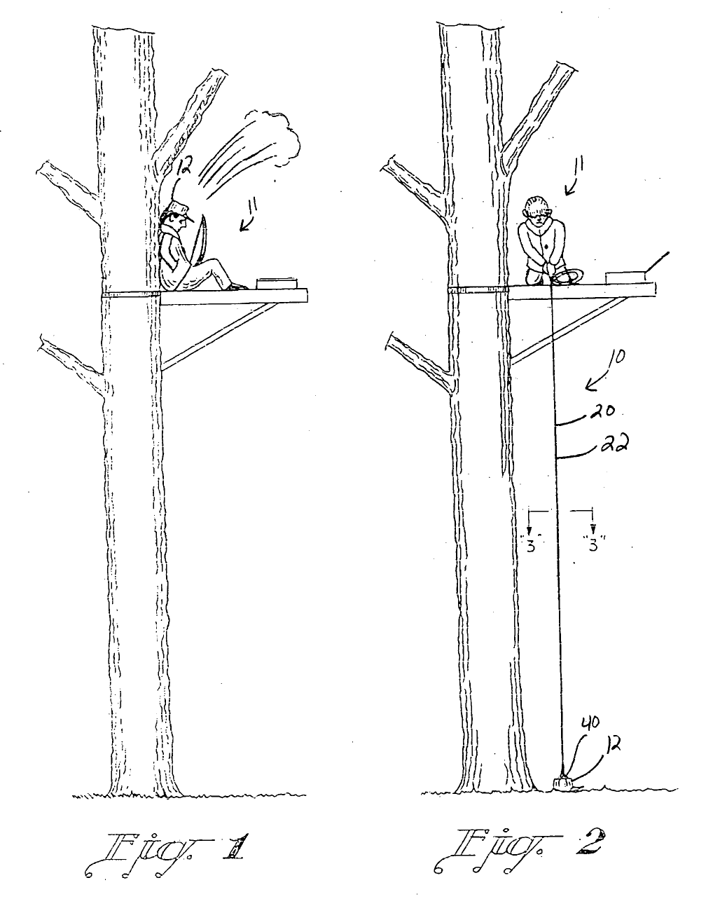

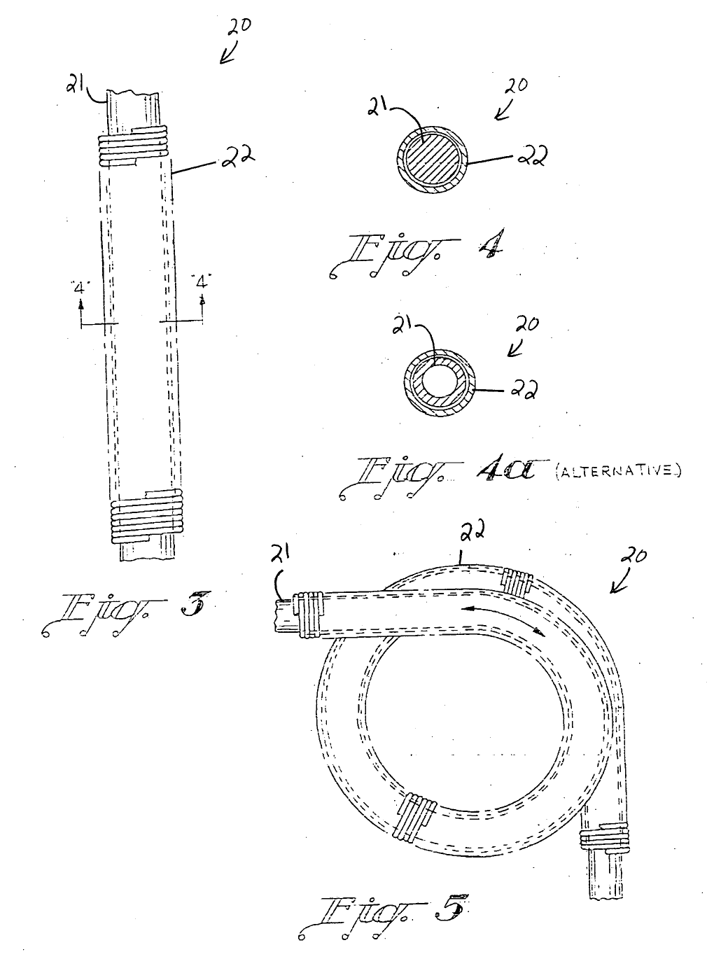

Referring now to the drawings, the preferred embodiment of the present invention concerns a coilable, article-retrieving assembly, device or apparatus 10 as generally illustrated and referenced in FIGS. 2, 6, 7, 10, and 11. From a general consideration of FIGS. 1, 2, and 11, however, it will be understood that the preferred article-retrieving apparatus 10 of the present invention is designed so as to enable a user 11 (located in a superior position) to retrieve articles (such as a hat, a glove, a bow, a gun, etc.) inferiorly located relative to the superiorly located user 11.

As earlier noted, hunters expend considerable amounts of energy climbing to elevated vantage points in the search for their prey. If a much-needed article is dropped from the elevated position, the hunter must often descend from his or her perch to retrieve the article, thereby expending further energy, increasing one's body heat (and associated prey-repelling scents), and causing an otherwise considerable amount of prey-repelling distraction. In short, the appeal of having to descend from a hard-fought vantage point to retrieve a displaced article (such as hat 12) is virtually non-existent.

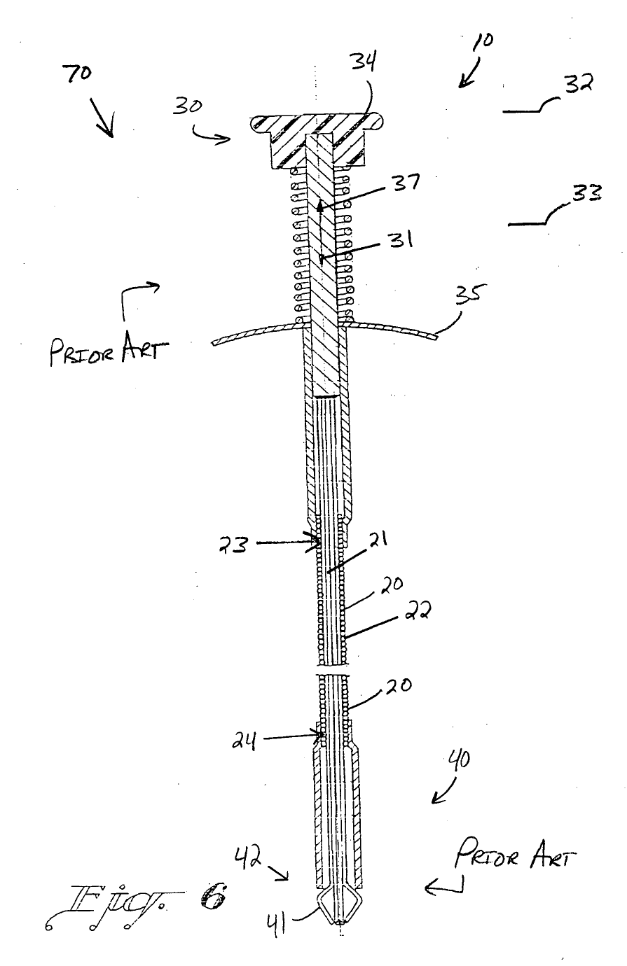

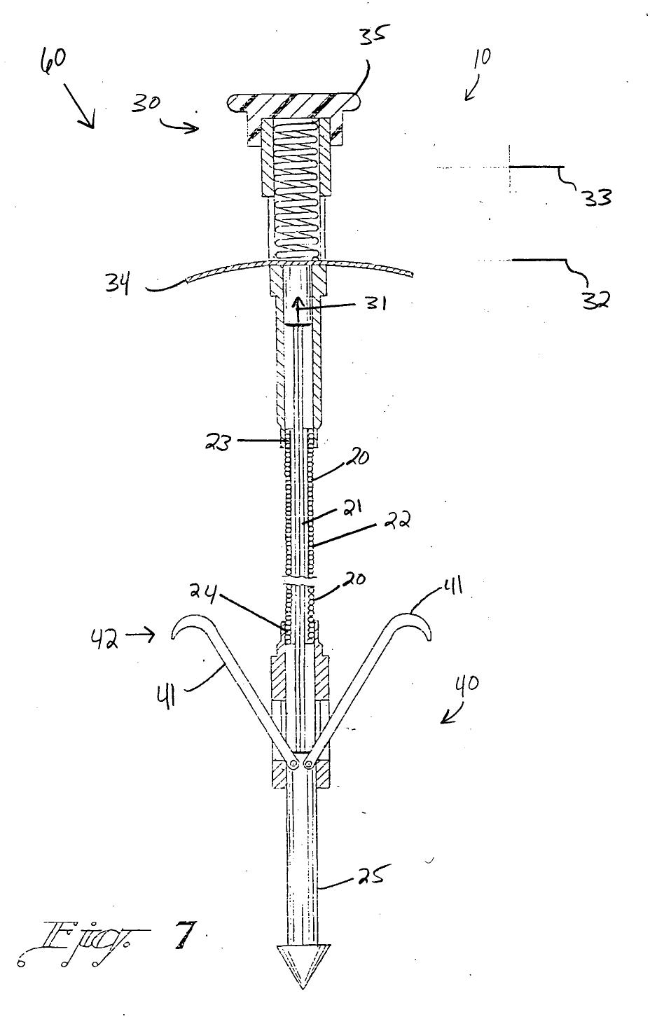

It is contemplated that the article-retrieving apparatus 10 of the present invention may provide the user 11 with a greatly beneficial accessory, saving the user 11 a great deal of energy and enhance the likelihood that the user 11 may secure the sought prize. The article-retrieving apparatus 10 thus generically comprises a coilable, distance-traversing sleeve assembly 20 as generally illustrated and referenced in FIGS. 2-9, and 11; a hand-operable, force-imparting handle assembly 30 as generally illustrated and referenced in FIGS. 6 and 7; and a claw assembly or an article-grabbing assembly 40 as generally illustrated and referenced in FIGS. 2, and 6-11.

The sleeve assembly 20 may preferably comprise a force-translating, coilable inner member 21 as illustrated and referenced in FIGS. 3-9; a force-guiding, coilable outer sleeve 22 as illustrated and referenced in FIGS. 2-9, and 11; a first sleeve assembly end 23 as generally referenced in FIGS. 6, 7, and 11; a second sleeve assembly end 24 as generally referenced in FIGS. 2, 6-9, and 11; and a sleeve assembly length (preferably on the order of 3 to 30 feet) as generally depicted in FIGS. 2 and 11. In other words, the sleeve assembly length may be selected from a length range, the length range ranging from about 3 feet to about 30 feet, which length range is discussed in more detail below.

It is contemplated that inner member 21 may preferably be constructed from low memory material having minimized (longitudinal) elasticity such as piano wire, electrical conductors, small diameter coil cables, cable rope, heavy test (fishing) line and the like. The outer sleeve is also preferably constructed from low(er) memory material having minimized (longitudinal) elasticity such as larger diameter coil cables, flexible electrical conduit, throttle cable, insulative sheathing, and the like. It will be understood that the inner member 21 is preferably slidably received within the outer sleeve 22 as generally depicted in FIGS. 3-9 and that the sleeve assembly length generally extends intermediate the first sleeve assembly end 23 and the second sleeve assembly end 24.

In this last regard, it is contemplated that the preferred length of present invention may range from about 3 feet in length to about 30 feet in length. Lengths shorter than about 3 feet may benefit from an assembly construction comprising certain high memory materials as is currently found in the prior art (as, for example, common mechanic's tools for retrieving tools and the like in the shop), and lengths greater than about 30 feet may experience too much play if the coilable sleeve assembly is fully extended. Excellent results have been shown when sleeve assembly 20 is on the order of about 30 feet.

Excess length may simply be coiled (as generally depicted in FIG. 2) at the user's end such that the force-imparting assembly 30 may function to still operate the article-grabbing assembly 40 even though the sleeve assembly 20 intermediate the assemblies 30 and 40 is coiled and the overall sleeve assembly length is otherwise shortened. It will thus be understood that the inner member 21 preferably comprises a first low memory construction and the outer sleeve 22 preferably comprises a second low memory construction, the second low memory construction having relatively lower memory as compared to the first low memory construction. The inner member 21 is thus uncoilable via contact with the :outer sleeve 22, which outer sleeve 22 is uncoilable primarily under gravitational force.

As earlier noted, certain prior art article-retrieving devices constructed from relatively high memory materials or relatively rigid materials and are relatively shorter in length (on the order of several feet at most). In this regard, it should be noted that sleeve assembly 20 is preferably constructed from low memory materials so that the assembly may be uncoiled under gravitational forces. Notably, however, it is preferred that the outer sleeve 22 be constructed from a material having lower memory than the material used in the construction of the inner member 21. The inner member 22 (constructed from a relatively higher memory material) would thus be more reluctant to uncoil under gravitational force than outer sleeve 22 (constructed from a relatively lower memory material) but would typically be better equipped to translate an operative force 31 directed thereagainst. Outer sleeve 22 functions primarily as a relative displacement sheath for the force-translating inner member 21 and thus uncoilablity is its primary feature and force-translatability is its secondary feature.

Under the force of gravity, the outer sleeve 22 functions to force inner member 21 into a substantially linear or plumb orientation such that the sleeve assembly 20 can be easily and manually positioned in superior adjacency to the articles to be fetched. In this last regard, it should be noted that the article-grabbing apparatus 10 may preferably further comprise certain assembly-plumbing means for maintaining a substantially vertical sleeve assembly portion when the inner member 21 and outer sleeve 22 are in an uncoiled state as generally depicted in FIGS. 2, 3, and 11. The assembly-plumbing means may simply be defined by an optionally magnetic plumb bob 25 (as illustrated and referenced in FIGS. 7 and 9, or similar other weighty construction or structure for ensuring complete uncoilability of the sleeve assembly 20 under gravitational force.

The hand-operable, handle assembly 30 is preferably mechanically coupled with or in cooperative mechanical communication with the first sleeve assembly end 23 and comprises certain hand-deliverable, force-imparting means (as may be defined by a movable first handle 34) as generally depicted in FIGS. 6 and 7; and certain sleeve-retaining means (as may be defined by a stationary second handle 35) as generally further depicted in FIGS. 6 and 7. The force-imparting means function to enable a user to impart a hand-deliverable operative force to the inner member 21 as generally depicted at force vectors 31 in FIGS. 6, 7, and 9. In this last regard, it will be noted that the hand-deliverable, force-imparting means is in direct mechanical communication with the inner member 21 for translating or imparting an operative force 31 thereto. The inner member 21 is thus hand-displaceable from an initial member position 32 as referenced in FIGS. 6 and 7, to a second member position 33 as referenced in FIGS. 6 and 7. The sleeve-retaining means function to hold the outer sleeve 22 stationary relative to the hand-displaceable inner member 21 so that the hand-originated operative force 31 may properly function to displace the inner member 21 relative to the outer sleeve 22.

It should be noted from a comparative inspection of FIGS. 6 and 7 that the inner member 21 may be displaced in either a first (generally downward) direction relative to the outer sleeve 22 or may be displaced in a second (generally upward) direction relative to the outer sleeve 22 for further delivering the operative force 31 to the article-grabbing assembly 40. In other words, the differing directional displacements function to operate differing article-grabbing assemblies, as is discussed in more detail hereinafter. The hand-originated operative force 31 may thus be said to selectively direct the inner member 21 for actuating the article-grabbing assembly 40 as selected or chosen from a select net displacement force. The select net displacement force is selected from the group consisting of a downwardly directed net displacement force as generally depicted in FIG. 6 and an upwardly directed net displacement force as generally depicted in FIG. 7.

It will be seen from an inspection of FIGS. 6 and 7 that the hand-operable handle assembly preferably comprises certain inner member-returning means. In other words, it is contemplated that after the inner member 21 is displaced via operative force 31, certain means may function to return the inner member to its initial position under, for example, a return force as referenced at vector 37 in FIG. 6. In this regard, the inner member-returning means may be defined by a compression coil 36. The compression coil, being strategically and structurally located, may function to return the inner member 21 to the initial member position 32 when operative force 31 is lesser than the return force 37.

It will be seen from a further inspection of FIGS. 6 and 7 that the structural configuration of article-grabbing apparatus 10 varies as between the two depictions. In this regard, it is contemplated that the essence of the invention lies in a lengthy, coilable and uncoilable device having force-imparting means and certain article-grabbing means associated with the lengthy intermediate structure. Any number of means may be utilized to achieve the essential function of the invention. For example, a well assembly typically comprises a length of coilable rope (a coil assembly), a bucket (article- or matter-grabbing means) and a spindle (force-imparting means). It is not intended that the language of this application be construed as to cover a common well type assembly as embodied by the foregoing, but to cover an apparatus defined by certain language appropriate to the scope of the present invention. Thus, at least two mechanical embodiments are shown and at least one electromechanical embodiment (although simplified) are shown and described in varying degrees in this application.

The first embodiment 70 of the article-grabbing apparatus 10 is modeled on certain prior art handle assemblies and certain prior art article-grabbing assemblies as taught by short length article grabbing devices. Notably, the intermediate lengths of these devices are constructed from relatively high memory materials. Although on occasion coilable under significant force, these prior art devices will return to their initial uncoiled state when the coiling force is removed. The intermediate coil assembly retains its coiled state or its uncoiled state due to its relatively low memory construction, which difference is believed significant as compared to the prior art. The second embodiment 60 of the present invention is believed to comprise no prior art components and operates by a handle-directed operative force 31 instead of a grabber-directed operative force 31. Both embodiments 60 and 70 are believed to fall within the scope of the present invention.

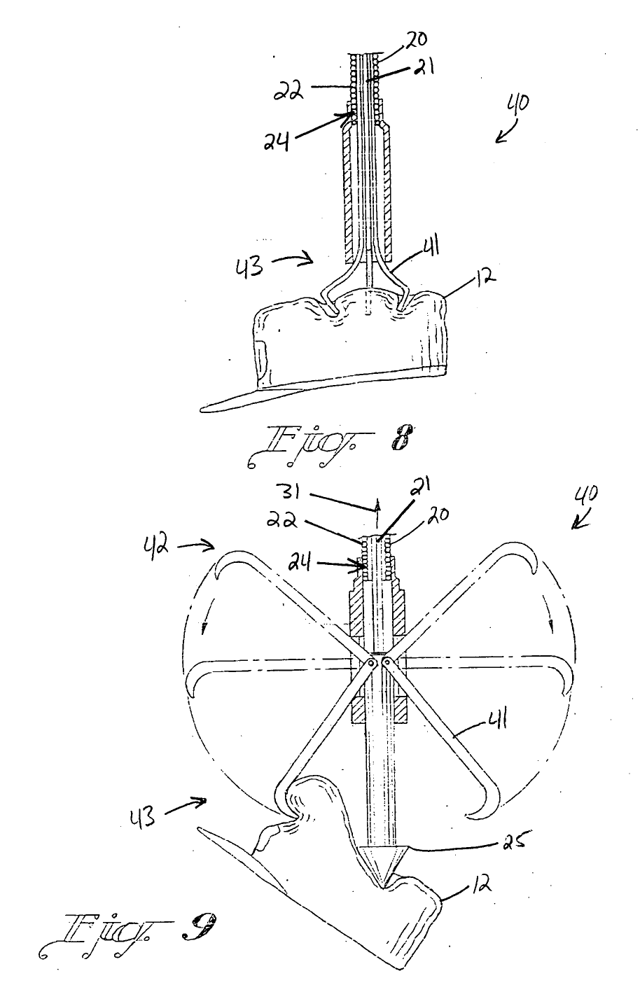

The claw assembly or article-grabbing assembly 40 is preferably mechanically coupled with or in cooperative mechanical communication with the second sleeve assembly end 24 and preferably comprises a plurality of cooperatively operative article-grabbing members 41 or an operative claw as generally illustrated and referenced in FIGS. 6-10. It will be seen from an inspection of the noted figures that the displaceable inner member 21 functions to actuate the article-grabbing members 41 from a first non-grabbing position 42 as generally depicted in FIGS. 6, 7, 9, and 10, to a second article-grabbing position 43 as generally depicted in FIGS. 8-10. Notably, the article-grabbing position 43 coincides with the retention of a fetchable article (such as hat 12) located inferior relative to the user 11. Notably, the article-grabbing position 43 coincides with a select member position, the select member position being selected from the group consisting of the initial member position 32 and the second member position 33 depending on whether the operative force 31 is directed toward the article-grabbing assembly 40 or away from the article-grabbing assembly 40. In this regard, it is noted that while the article-grabbing assembly 40 of the first embodiment 70 of the article-grabbing apparatus 10 may make an initial grabbing contact with an article at the second member position 33, the retention of the article is essentially achieved via the return force 37 as inner member 21 is drawn back to its initial member position 32 and it is this vein of engineering practice that the select member position may be selected from the group consisting of the initial member position 32 and the second member position 33 depending on whether the operative force 31 is directed toward the article-grabbing assembly 40 or away from the article-grabbing assembly 40. Stated another way, the article-grabbing assembly 40 may start from an initial, at-rest position and when the article-grabbing assembly 40 returns to this position, the same may well function to retain an article as would be the case with the embodiment illustrated in FIG. 6. Alternatively, when the article-grabbing assembly 40 is actuated to a second position (from an initial, at-rest position), the second position may well function to retain an article as would be the case with the embodiment illustrated in FIG. 7.

Preferably the article-grabbing position 43 may be locked by certain position-locking means cooperatively associated with the handle assembly 30 (not specifically illustrated). In any event, the sleeve assembly 20 is manually coilable for decreasing the vertical distance intermediate the user 11 and the article-grabbing assembly 40 as selectively outfitted with the retained fetchable article as generally depicted in FIG. 11. Thus, the coilable article-retrieving apparatus 10 may function to retrieve articles located inferior relative to the user 11. Notably, plumb bob 25 is illustrated as having a pointed end. In this regard, it is contemplated that article-grabbing apparatus 10 may preferably be constructed so that when uncoiled or lowered from a superior position, the terminus comprises structure for guiding the article-grabbing assembly 40 through adjacent structure such as branches of a tree or roots in a well or similar other obstacles.

The user 11 as depicted in FIGS. 1, 2, and 11 did not have to descend to the dropped hat 12, but merely had to unpackage his (coiled) coilable article-retrieving apparatus 10 as constructed from low memory materials, uncoil the article-retrieving apparatus 10 under the force of gravity and position the article-grabbing assembly 40 over the hat 12. Once the article-grabbing assembly 40 was in a suitable position, the user 11 operated the handle assembly by imparting some operative force 31 thereto, which operative force served to operate or actuate the article-grabbing assembly 40 to grab and retain the hat 12. After the hat 12 was grabbed and retained, the user 11 manually recoiled the article-retrieving apparatus 10 and thus decreased the vertical distance intermediate the user 11 and the dropped hat 12 so that the user 11 may once again don the article, keep his head warm, and return to his primary concern with minimal environmental disturbance and minimized personal effort.

It should be noted that the article-grabbing apparatus need not be limited to hunting uses and thus may well function to aid users in need of retrieving dropped articles at varying heights. A sleeve assembly length of about 3 feet, for example, may well function to aid users in and around a household. If, for example, a laundered or yet-to-be laundered article is dropped behind a laundry machine, the user 11 of the present invention as having a 3-foot sleeve assembly length could uncoil (i.e. drop) the article-grabbing assembly 40 in superior adjacency to the dropped article and grab the dropped article as per the foregoing specifications. Notably, the user 11 does not drop or uncoil the handle assembly else article-retrieving apparatus 10 may be dropped and thus be in need of retrieval. In this regard, it is contemplated that handle assembly 30 or the first sleeve assembly end 23 may preferably comprise certain connecting means for retaining the apparatus 10 in adjacency to the user 11, such as a locking strap, or even Browning's GEAR ‘TRIEVER brand retractable cable system (Browning Corporation Utah, One Browning Place, Morgan, Utah, 84050), which system ostensibly has been made the separate subject of an application for U.S. Letters Patent.

It will be recalled that the article-grabbing apparatus 10 may preferably comprise certain assembly-plumbing means. Bearing this feature in mind, it is further contemplated that the article-grabbing members 41 may cooperate with the assembly-plumbing means for enhancing fetchable article retention. In other words, it is contemplated that when article-grabbing assembly 40 is actuated via operative force 31, the article-grabbing members 41 may close upon the fetchable article and the assembly-plumbing means as thus grab the fetchable article intermediate the article-grabbing members 41 and the exemplary plumb bob 25 (which may itself be outfitted with certain hooks, prongs, or similar other article-catching means) to enhance the retention of the (then) fetched article as the sleeve assembly 20 is manually coiled and the fetched article is retrieved. A further means for enhancing article retention may be the outfitted use of at least one magnetic component at or adjacent the article-grabbing assembly 40 or the second sleeve assembly end 24. Thus, it is contemplated that the article-grabbing assembly 40 or the second sleeve assembly end 24 may preferably comprises at least one magnetic component enhancing fetchable article retention.

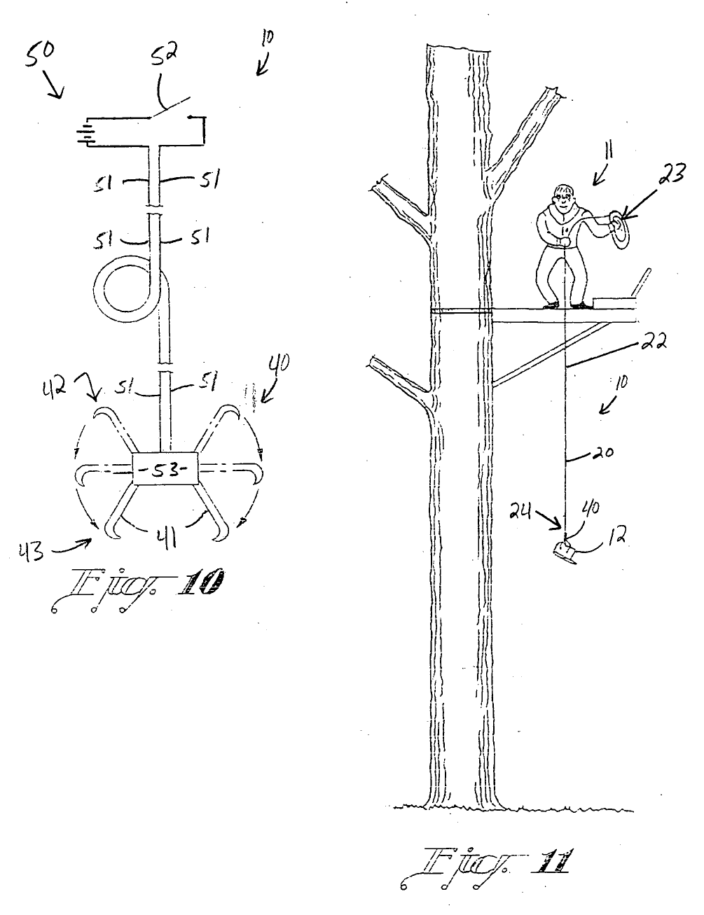

While the foregoing descriptions set forth much specificity, the same should not be construed as limiting the essence of the present invention, but rather as setting forth the preferred means for retrieving an article as otherwise displaced from the user. For example, it is believed that the sprit of the present invention teaches an article-retrieving assembly for retrieving articles located distant relative to a user, which article-retrieving assembly comprises a coil assembly, certain force-imparting means, and an article-grabbing assembly. It is contemplated that the coil assembly essentially comprises certain force-communicating, force-guiding means as may be defined by sleeve assembly 20 or as may be defined by certain circuitry as included in an electromechanical article-retrieving apparatus 50 as generally diagrammatically referenced in FIG. 10. In this regard, it is conceivable that a length of circuit-enabling wire or conductors 51 may be coilable and uncoilable for traversing certain vertical distances per the foregoing specifications. Further, circuit-enabling wire or conductors 51 function to communicate certain forces and guide certain forces. So long as the coil assembly comprises a first force-imparting end, a second force-actuating end, and a force-translating length extending intermediate the force-imparting end and the force-actuating end, it is believed that the essence of the distance-traversing structure of the disclosed invention is taught.

The force-imparting means such as handle assembly or an operative switch 52 in cooperative communication with the force-imparting end enable a user to impart an operative force (such as a mechanical force or an electromotive force) to the force-communicating, force-guiding means. The article-grabbing assembly is in cooperative communication with the force-actuating end and comprises an article-grabbing claw or member. The operative force functions to actuate the article-grabbing claw from a first non-grabbing position to a second grabbing position (as may be achieved via black box type electromechanical structure 53 opposite the switch 52).

The article-grabbing position retains a fetchable article located distant relative to the user and the coil assembly is coilable for decreasing the distance intermediate the user and the article-grabbing assembly as selectively outfitted with the retained fetchable article.

Accordingly, although the invention has been described by reference to a preferred embodiment, it is not intended that the novel disclosure be limited thereby, but that modifications thereof are intended to be included as falling within the broad scope and spirit of the foregoing disclosure, the following claims and the appended drawings.

I claim:

1. An article-retrieving system, the article retrieving system for retrieving articles located inferior relative to a user, the article retrieving system comprising:
a coilable sleeve assembly, the coilable sleeve assembly comprising a force-translating, coilable inner member, a force-guiding, coilable outer sleeve, a first sleeve assembly end, a second sleeve assembly end, and a sleeve assembly length, the inner member being slidably received within the outer sleeve, the sleeve assembly length extending intermediate the first and second sleeve assembly ends;
a hand-operable, handle assembly, the handle assembly being in cooperative mechanical communication with the first sleeve assembly end comprising hand-deliverable force-imparting means and sleeve-retaining means, the force-imparting means for enabling a user to impart a hand-deliverable operative force to the inner member, the inner member thus being hand-displaceable from an initial member position to a second member position, the sleeve-retaining means for holding the outer sleeve stationary relative to the hand-displaceable inner member, the hand-deliverable operative force for displacing the inner member relative to the outer sleeve; and
an article-grabbing assembly, the article-grabbing assembly being in cooperative mechanical communication with the second sleeve assembly end comprising a plurality of cooperatively operative article-grabbing members, the displaceable inner member for actuating the article-grabbing members from a first non-grabbing position to a second article-grabbing position, the article-grabbing position for retaining a fetchable article located inferior relative to the user, the sleeve assembly being manually coilable for decreasing the vertical distance intermediate the user and the article-grabbing assembly as selectively outfitted with the retained fetchable article, the article-retrieving system thus for retrieving articles located inferior relative to the user.

2. The article-retrieving system of claim 1 wherein the sleeve length is selected form a length range, the length range ranging from about 3 feet to about 30 feet.

3. The article-retrieving system of claim 1 wherein the inner member comprises a first low memory construction and the outer sleeve comprises a second low memory construction, the second low memory construction having lower memory than the first low memory construction, the inner member being uncoilable via contact with the outer sleeve, the outer sleeve being uncoilable under gravitational force.

4. The article-retrieving system of claim 1 wherein the article-grabbing assembly comprises assembly-plumbing means, the assembly-plumbing means for maintaining a substantially vertical sleeve assembly portion when the inner member and outer sleeve are in an uncoiled state.

5. The article-retrieving system of claim 4 wherein the article-grabbing members cooperate with the assembly-plumbing means for enhancing fetchable article retention.

6. The article-retrieving system of claim 5 wherein the article-grabbing assembly comprises at least one magnetic component, the magnetic component for enhancing fetchable article retention.

7. The article-retrieving system of claim 1 wherein the hand-deliverable operative force selectively directs the inner member for actuating the article-grabbing assembly, the operative force selectively directing the inner member as chosen from a select net displacement force, the select net displacement force being selected from the group consisting of a grabber-directed net displacement force and a handle-directed net displacement force.

8. The article-retrieving system of claim 7 the handle assembly comprises inner member-returning means, the inner member-returning means for returning the inner member to the initial member position.

9. The article-retrieving system of claim 8 wherein the article grabbing position coincides with a select member position, the select member position being selected from the group consisting of the initial member position and the second member position.

10. An article-retrieving assembly, the article-retrieving assembly for retrieving articles located distant relative to a user, the article-retrieving assembly comprising:
a sleeve assembly, the sleeve assembly comprising a force-translating, coilable inner member, a force-guiding, coilable outer sleeve, a first sleeve assembly end, a second sleeve assembly end, and a sleeve assembly length, the inner member being slidably received within the outer sleeve, the sleeve assembly length extending intermediate the first and second sleeve assembly ends;
a handle assembly, the handle assembly being in cooperative communication with the first sleeve assembly end comprising force-imparting means and sleeve-retaining means, the force-imparting means for enabling a user to impart an operative force to the inner member, the inner member thus being displaceable from an initial member position to a second member position, the sleeve-retaining means for holding the outer sleeve stationary relative to the inner member, the operative force for displacing the inner member relative to the outer sleeve; and
an article-grabbing assembly, the article-grabbing assembly being in cooperative communication with the second sleeve assembly end comprising cooperative article-grabbing members, the displaceable inner member for actuating the article-grabbing members from a non-grabbing position to an article-grabbing position, the article-grabbing position for retaining a fetchable article located distant relative to the user, the sleeve assembly being manually coilable for decreasing the distance intermediate the user and the article-grabbing assembly as selectively outfitted with the retained fetchable article, the article-retrieving assembly thus for retrieving articles distantly located relative to the user.

11. The article-retrieving assembly of claim 10 wherein the sleeve length is of a measured magnitude ranging from about 3 feet to about 30 feet.

12. The article-retrieving assembly of claim 10 wherein the inner member is uncoilable via contact with the outer sleeve and the outer sleeve is uncoilable under gravitational force.

13. The article-retrieving assembly of claim 10 wherein the article-grabbing assembly comprises assembly-plumbing means, the assembly-plumbing means for maintaining a substantially vertical sleeve assembly portion when the inner member and outer sleeve are in an uncoiled state.

14. The article-retrieving assembly of claim 13 wherein the article-grabbing members cooperate with the assembly-plumbing means for enhancing fetchable article retention.

15. The article-retrieving assembly of claim 10 wherein the article-grabbing assembly comprises at least one magnetic component, the magnetic component for enhancing fetchable article retention.

16. The article-retrieving assembly of claim 10 wherein the hand-deliverable operative force selectively directs the inner member for actuating the article-grabbing members, the operative force selectively directing the inner member as chosen from a select net displacement force, the select net displacement force being selected from the group consisting of a grabber-directed net displacement force and a handle-directed net displacement force.

17. The article-retrieving assembly of claim 10 comprising inner member-returning means, the inner member-returning means for returning the inner member to the initial member position.

18. The article-retrieving assembly of claim 10 wherein the article-grabbing position coincides with a select member position, the select member position being selected from the group consisting of the initial member position and the second member position.

19. An article-retrieving assembly, the article-retrieving assembly for retrieving articles located distant relative to a user, the article retrieving assembly comprising:
a coil assembly, the coil assembly comprising force-communicating, force-guiding means, a first force-imparting end, a second force-actuating end, and a force-translating length, the force-translating length extending intermediate the force-imparting end and the force-actuating end;
force-imparting means, the force-imparting means being in cooperative communication with the force-imparting end, the force-imparting means for enabling a user to impart an operative force to the force-communicating, force-guiding means; and
article-grabbing means, the article-grabbing means being in cooperative communication with the force-actuating end, the operative force for actuating the article-grabbing means from a first non-grabbing position to a second article-grabbing position, the article-grabbing position for retaining a fetchable article located distant relative to the user, the coil assembly being coilable for decreasing the distance intermediate the force-imparting end and the force-actuating end, the article-retrieving assembly thus for retrieving articles distantly located relative to the user.

20. The article-retrieving assembly of claim 19 wherein the force-communicating, force-guiding means are defined by a sleeve assembly, the sleeve assembly comprising an inner member slidably received in an outer sleeve, the inner member comprising a first low memory construction and the outer sleeve comprising a second low memory construction, the second low memory construction having lower memory than the first low memory construction, the inner member being uncoilable via contact with the outer sleeve, the outer sleeve being uncoilable under gravitational force, the sleeve assembly for traversing vertical distance intermediate the force-imparting end and the force-actuating end, the article-retrieving assembly thus for retrieving articles located inferior relative to the user.
